(19) United States
(12) Patent Application Publication
(10) Pub. No.: US 2018/0363261 A1
(43) Pub. Date: Dec. 20, 2018

(54) DEVICE FOR REMOVING FOG USING HYBRID-TYPE ANION GENERATING DEVICE

(71) Applicant: Oh Jun KWON, Seoul (KR)

(72) Inventor: Oh Jun KWON, Seoul (KR)

(21) Appl. No.: 15/562,987

(22) PCT Filed: May 3, 2016
(86) PCT No.: PCT/KR2016/004682

§ 371 Date: Sep. 29, 2017

(30) Foreign Application Priority Data
May 29, 2015 (KR) 10-2015-0075925

(51) Int. Cl. E01H 13/00; B03C 3/017; B03C 3/38; B03C 3/68; B03C 1/23; H01T 23/00; H02J 7/35

(52) U.S. Cl. CPC E01H 13/00; B03C 3/017; B03C 3/38; B03C 3/68; C22C 1/02; H01T 23/00; H02J 7/35; B03C 2201/30; B03C 1/23

(57) ABSTRACT

Disclosed herein is a device for removing fog using a hybrid-type anion generating device, the device including: a support body (100) configured to protect individual devices from external pressure; a solar panel (200) configured to charge electricity into a rechargeable battery; a fog sensor module (300) configured to analyze whether the fog in question is thick fog or thin fog; a hybrid-type anion generating device (400) configured to generate anions by means of a hybrid method; the smart control unit (500) configured to control the overall operation of the individual devices, and to perform control so that input fog data and system normality or abnormality data are transmitted to a firefighting control center; and a charge control module (600) configured to perform control so that any one of electricity generated by the solar panel and electricity supplied from a commercial power is selected and charged into the rechargeable battery.

### TECHNICAL FIELD

The present invention relates to a device for removing fog using a hybrid-type anion generating device, which is capable of: generating anions by means of a hybrid method using both corona discharge plasma and an electromagnetic field; generating an inverted “V”-shaped shelter membrane by transmitting electromagnetic field anions in a direction toward the upper end of a specific space, thereby dispersing fog located within the internal space of the inverted “V”-shaped shelter membrane by using the electromagnetic field anions; and transmitting corona discharge plasma anions in a direction in which a vehicle moves forward, thereby dispersing fog generated in the direction in which the vehicle moves forward.

### BACKGROUND ART

With the development and diversification of industry, losses of both life and property attributable to thick fog occur frequently, and the scales of the losses increase.

Fog which is generated on a road, along a coastal area, and within an airport results in massive damage to transportation business, etc. using vehicles, ships, and airplanes.

Fog on a road highly influences the occurrence of traffic accidents.

According to the statistics of the Korean Road Traffic Safety Authority over a period ranging from 2004 to 2006, foggy days cause visibility obstruction, and thus result in a four-fold increase in the number of deaths over sunny days, rainy days, or snowy days.

In order to disperse such fog, various schemes are being sought. These schemes mainly include technologies based on seeding using a hygroscopic material, a strong wind, heating using heat, etc.

As a conventional fog dispersion device, Korean Patent No. 10-1387710 discloses an active fog dispersion system including a fog dispersion device unit configured to inject blasts of hot air, a plurality of supports, a foggy visible distance measurement unit, a rainfall/snowfall sensor unit, a fog dispersion control unit, and a remote management unit.

This fog dispersion system has problems in that the high cost is incurred because the consumption of energy used to generate blasts of hot air is high and street trees wither due to exposure to discharged blasts of hot air.

Furthermore, the supports are formed to be oriented only to one direction in a fixed form, and thus blasts of hot air are injected only in a specific direction. Accordingly, fog cannot be dispersed in all directions around the supports, and thus a problem occurs in that fog dispersion rate is somewhat low.

Furthermore, the conventional fog dispersion devices are made of general metallic materials, and thus have a problem in that they are easily worn or corroded when they come into contact with impurities, such as fog, rainwater, and snow.

### PRIOR ART DOCUMENT

(Patent document 1) Korean Patent No. 10-1387710

### DISCLOSURE

### Technical Problem

In order to overcome the above-described problems, an object of the present invention is to provide a device for removing fog using a hybrid-type anion generating device, which can be easily installed because the device is made of a material which is lightweight and has desirable wear resistance and corrosion resistance, which is not easily worn or corroded even when impurities enter, which can generate anions by means of a hybrid method using both corona discharge plasma and an electromagnetic field, which charges electrical energy, generated via a solar panel, into a rechargeable battery for 50% of the total power, which can receive power via a commercial power source for 50% of the total power and can supply the power to individual devices, which can adjust a corona discharge plasma anion module within the angular range from 10° to 70° in a vertical direction, which can rotate the corona discharge plasma anion module within the range from 1° to 360° in all directions, and which can be widely applied to and installed on/at/in a road, a bridge, an airport, a protective facility, an outdoor stage, a sports facility, a vinyl house, a worksite, and a construction site.

### Technical Solution

In order to accomplish the above object, the present invention provides a device for removing fog using a hybrid-type anion generating device, the device including:

a support body (100) formed to be upright in a vertical direction, and configured to protect individual devices from external pressure and to support them;

a solar panel (200) located on one side of the upper end of the support body, and configured to collect solar light, to generate electricity, and to charge the generated electricity into a rechargeable battery;

a fog sensor module (300) located on one side below the solar panel, and configured to emit infrared rays forward, to receive infrared rays which hit fog particles and are scattered and returned, to analyze whether the fog in question is thick fog or thin fog, and to transfer fog analysis data to a smart control unit;

a hybrid-type anion generating device (400) located on one side of the center portion of the support body, and configured to be driven in response to a control signal from the smart control unit, to generate anions by means of a hybrid method using both corona discharge plasma and an electromagnetic field, and to disperse fog;

the smart control unit (500) connected to the fog sensor module and the hybrid-type anion generating device, and configured to control the overall operation of the individual devices, to receive fog data detected by the fog sensor module and perform control so that a drive control signal is output to the hybrid-type anion generating device, and to perform control so that the input fog data and system normality or abnormality data obtained for each set period are transmitted to a firefighting control center over a WiFi wireless communication network; and

a charge control module (600) located on one side of the lower end portion of the support body, and configured to perform control so that any one of electricity generated by the solar panel and electricity supplied from a commercial power is selected and charged into the rechargeable battery.

### Advantageous Effects

As described above, the present invention has desirable effects in that the device for removing fog is made of an magnesium alloy and, thus, is lightweight and has desirable wear resistance and corrosion resistance, in that anions can be generated according to a hybrid method using both corona discharge plasma and an electromagnetic field and thus the device for removing fog provides an anion generation effect twice that of the conventional device, has low radio wave interference, and produces a low amount of ozone, thereby improving fog dispersion rate by 80% compared to the conventional technology, in that electrical energy generated via the solar panel can be charged into the rechargeable battery for 50% of the total power, and power can be received from a commercial power source for 50% of the total power and can be supplied to the individual devices, thereby reducing the waste of electrical energy by 60% compared to the conventional technology, in that the corona discharge plasma anion module can be adjusted within the angular range from 10° to 70° and can be rotated within the range from 1° to 360° in all directions, thereby dispersing fog while varying the location of the corona discharge plasma anion module in all directions, and in that the device for removing fog can be widely applied to and installed on/at/in a road, a bridge, an airport, a protective facility, an outdoor stage, a sports facility, a vinyl house, a worksite, and a construction site and, thus, has desirable compatibility and provides stimulation to the fields of fog dispersion devices and facilities.

### DESCRIPTION OF DRAWINGS

FIG. 1 is a block diagram showing the components of a device (1) for removing fog using a hybrid-type anion generating device according to the present invention;

FIG. 2 is a perspective view showing the components of the device (1) for removing fog using a hybrid-type anion generating device according to the present invention;

FIG. 3 is a block diagram showing the components of a fog sensor module according to the present invention,

FIG. 4 is a block diagram showing the components of a corona discharge plasma anion module according to the present invention;

FIG. 5 is a block diagram showing the components of an electromagnetic field anion module according to the present invention;

FIG. 6 is a view showing an embodiment in which via electromagnetic field anion generation unit according to the present invention, magnets for generating a magnetic field are mounted inside a hollow cylindrical metallic pipe in a depression and protrusion form and electromagnetic field anions are generated by generating an eddy flow, i.e., an irregular flow, in air entering from an air feed unit;

FIG. 7 is a view showing an embodiment in which an electromagnetic field anion injection unit according to the present invention pulverizes electromagnetic field anions, generated via the electromagnetic field anion generation unit and injects the electromagnetic field anions into the outside and an electromagnetic field anion supply pipe feeds the electromagnetic field anion, generated via the electromagnetic field anion generation unit, to linear anion injection nozzles;

FIG. 8 is a block diagram showing the components of a smart control unit according to the present invention;

FIG. 9 is a view showing a configuration for receiving fog analysis data, obtained via a fog sensor module, from the smart control unit according to the present invention and selecting and driving any one of an inverted “V”-shaped shelter membrane formation mode and a vehicle movement direction beam formation mode when the input fog analysis data corresponds to thick fog;

FIG. 10 is a block diagram showing the components of a charge control module according to the present invention;

FIG. 11 is a view showing an embodiment of the detailed operation process of the device for removing fog using a hybrid-type anion generating device according to the present invention;

FIG. 12 is a perspective view showing an operation in which an inverted “V”-shaped shelter membrane formation mode according to the present invention is driven, and an inverted “V”-shaped shelter membrane is generated by transmitting electromagnetic field anions in a direction toward the upper end of a specific space, thereby dispersing fog located within the internal space of the inverted “V”-shaped shelter membrane by means of the electromagnetic field anions, and an operation in which a vehicle movement direction beam formation mode is driven, and corona discharge plasma anions are transmitted in a direction in which a vehicle moves forward, thereby dispersing fog generated in the direction in which the vehicle moves forward by means of the corona discharge plasma anions; and

FIG. 13 is a front view showing an operation in which an inverted “V”-shaped shelter membrane formation mode according to the present invention is driven, and an inverted “V”-shaped shelter membrane is generated by transmitting electromagnetic field anions in a direction toward the upper end of a specific space, thereby dispersing fog located within the internal space of the inverted “V”-shaped shelter membrane by means of the electromagnetic field anions, and an operation in which a vehicle movement direction beam formation mode is driven, and corona discharge plasma anions are transmitted in a direction in which a vehicle moves forward, thereby dispersing fog generated in the direction in which the vehicle moves forward by means of the corona discharge plasma anions.

### MODE FOR INVENTION

The present invention relates to fog dispersion technology based on a hybrid-type anion generating device using both corona discharge plasma and strong magnetic force, in which particles in the atmosphere are ionized and ions draw and condense fog particles while acting as condensation nuclei, thereby allowing fog to fall in the form of raindrops.

In this case, a large amount of latent heat is released during the condensation of water drops, a convection current phenomenon occurring when fog is heated and raised due to the latent heat destroys a stable fog layer, and fog particles in a vapor form are raised, expanded, cooled, condensed, and finally fall in the form of raindrops, thus resulting in the dispersion of the fog.

Preferred embodiments according to the present invention will be described below with reference to the accompanying drawings.

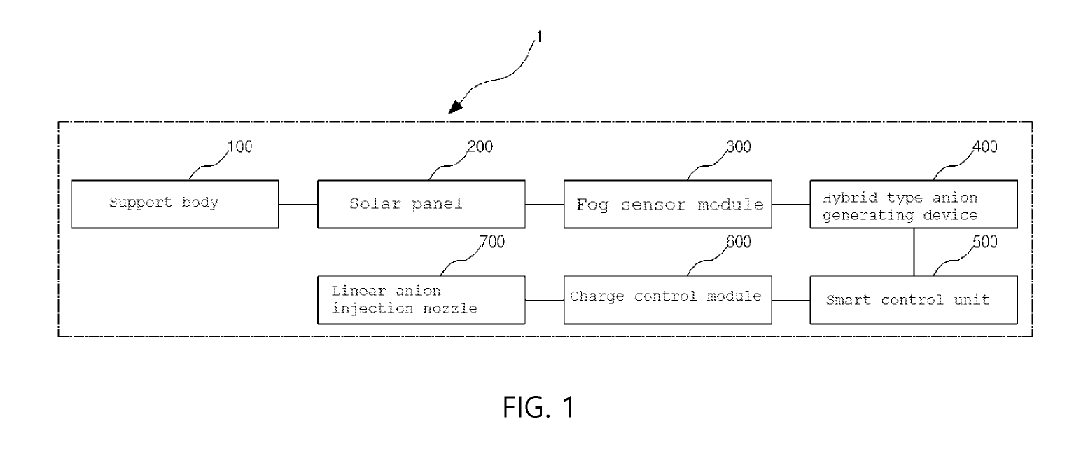

FIG. 1 is a block diagram showing the components of a device 1 for removing fog using a hybrid-type anion generating device according to the present invention. The device 1 includes a support body 100, a solar panel 200, a fog sensor module 300, a hybrid-type anion generating device 400, a smart control unit 500, and a charge control module 600.

First, the support body 100 according to the present invention is described.

The support body 100 is formed to be upright in a vertical direction, and functions to protect individual devices from external pressure and to support them.

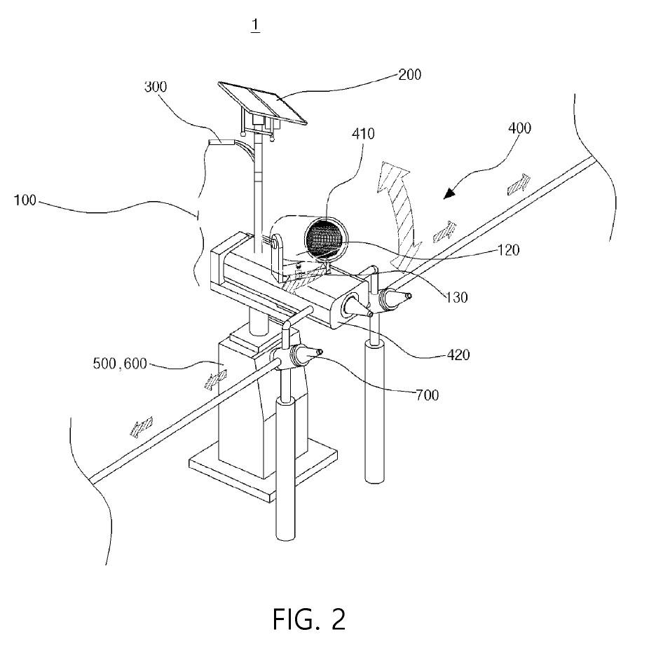

As shown in FIG. 2, the solar panel is formed on one side of the upper end portion, the fog sensor module is formed on one side below the solar panel, the hybrid-type anion generating device is formed on one side of the center portion, the charge control module is formed on one side of the lower end portion, and the smart control unit is formed on one side of the internal space.

As shown in FIG. 2, the support body according to the present invention is configured to include: a depression-type auxiliary frame 110 configured to support a corona discharge plasma anion module in a lateral direction; and a vertical angle adjusting unit 120 disposed on one side of the depression-type auxiliary frame, and configured to adjust the angle of the corona discharge plasma anion module within the range from 10° to 70°.

Furthermore, as shown in FIG. 2, the support body is configured to include a rotation adjusting unit 130 disposed on one side below the corona discharge plasma anion module and configured to rotate the overall corona discharge plasma anion module within the range from 1° to 360° in all directions.

As described above, the corona discharge plasma anion module can be rotated within the angular range from 10° to 70° in the vertical direction, and the solar panel, the fog sensor module, and the hybrid-type anion generating device can be all rotated within the range from 1° to 360° in all directions, thereby varying the location in all directions and then dispersing fog.

Furthermore, a warning light is configured to be attached onto one side of the support body 100 according to the present invention.

In this case, the warning light functions to be operated in response to a control signal from the smart control unit and to notify a vehicle driver of the occurrence of thick fog via warning sound or RGB color light emission.

Furthermore, the support body according to the present invention is made of a magnesium alloy which is lightweight and has desirable wear resistance and corrosion resistance (the ability to withstand corrosion).

Magnesium has a specific gravity of 1.74 g/cm³ and is thus 35% or more lighter than aluminum (having a specific gravity of 2.70 g/cm³), and has strength and flexural modulus superior to those of aluminum. In particular, magnesium is the lightest of structural metals, and is an environment-friendly material which has high specific strength and which can be easily recycled.

In the present invention, the support body is made of a magnesium alloy formed by producing a basic magnesium alloy having desirable mechanical characteristics, such as desirable lightweightness, desirable wear resistance, etc., enhancing corrosion resistance via an anodizing coating process, and additionally enhancing wear resistance.

A magnesium alloy forms solid solutions along with various elements, such as Al, Zn, Zr, Mn, Li, Ca, RE (Ce, La, and Nd), Si, etc., and may be used for various purposes. An important factor for the determination of an alloy element for magnesium is a relative difference between the sizes of respective atoms. The size of the atom of magnesium is 0.320 nm, and, generally, an alloy element with an atom size having a difference equal to or less than about 15% is preferable.

The magnesium alloy according to the present invention is produced by adding Zn and Sn to a basic Mg alloy billet, and is produced according to the following process:

The basic Mg alloy billet, including 6.0 Al, 0.008 Cu, 0.004 Fe, 0.4 Mn, 0.008 Si, 0.2 Zn, and the remainder Mg, is melted and cast along with Zn and Sn in an electric resistance furnace.

The magnesium alloy is formed by loading 0.5-2.0 wt % Sn, 0.5-2.0 wt % Zn, and the remainder Mg alloy billet into a graphite crucible, melting the loaded materials while preventing a melt from being oxidized by means of air and SF gas, and casting the melt under gravity by pouring the melt according to a top riser method.

In this case, the crucible and the mold are preheated to a temperature of 200° C. or higher and then used in order to primarily evaporate moisture and reduce a difference in temperature with respect to a melt.

Furthermore, the magnesium alloy is subjected to a coating process in order to improve corrosion resistance and wear resistance characteristics.

Representative processing methods for the anodizing coating process include galvanic anodizing, chemical treatment No. 17, HAE Treatment, and Cr-22 treatment.

The coating layer formed on the surface of magnesium through the above coating process has a dense structure, and imparts desirable corrosion resistance and wear resistance characteristics.

In the coating process, first, the magnesium alloy is ultrasonically cleaned with ethyl alcohol C₂H₅OH and distilled water for 30 seconds.

A mixture solution is prepared by mixing an aqueous solution of potassium permanganate with an aqueous solution of sodium hydroxide at a weight ratio of 1:3 to 4, a magnesium alloy is dipped in the mixture solution for 4 to 5 minutes in the state in which the mixture solution is being maintained at a temperature of 50 to 70° C., the magnesium alloy is taken out of the mixture solution, the magnesium alloy is washed with water, air blowing is performed on the magnesium alloy, and the magnesium alloy is dried at 100° C. for 5 to 10 minutes, thereby forming the coating layer.

The mixing percentage of the aqueous solution of sodium hydroxide influences the uniform and dense formation of a thin plate-shaped coating layer. When the quantity of the aqueous solution of sodium hydroxide deviates from a threefold to fourfold range, it is difficult to expect the above effect. Accordingly, it is preferable to maintain the presented mixing ratio between the aqueous solution of potassium permanganate and the aqueous solution of sodium hydroxide.

Furthermore, the temperature of the solution influences a corrosion speed delay effect attributable to the coating layer. When the temperature of the solution is lower than 50° C., a corrosion reduction effect is achieved, but a corrosion speed reduction effect is not obtained. In contrast, when the temperature of the solution is higher than 70° C., a corrosion speed reduction effect is small and thus insignificant. Accordingly, it is preferable to maintain the temperature of the solution within the presented range.

Next, the solar panel 200 according to the present invention is described.

The solar panel 200 is located on one side of the upper end of the support body, and functions to collect solar light, to generate electricity, and to charge a rechargeable battery with the generated electricity.

The solar panel 200 is formed by stacking solar cells made of gallium arsenide GaAs in a multi-layer form.

In other words, solar cells connected in series or parallel with each other by an interconnector made of aluminum metal foil are formed on the surface of the solar panel.

In this case, the number of solar cells connected in series is determined based on the charging capacity of the rechargeable battery.

The interconnector configured to connect the individual solar cells is connected to (+) and (−) power terminals plated on one side of a PCB.

In the present invention, a setting is made such that electrical energy generated via the solar panel is charged into the rechargeable battery for 50% of the total power. Next, the fog sensor module 300 according to the present invention is described.

The fog sensor module 300 is located on one side below the solar panel, and functions to emit infrared rays forward, to receive infrared rays which hit fog particles, are scattered and returned, to analyze whether the fog in question is thick fog or thin fog, and to transfer fog analysis data to the smart control unit.

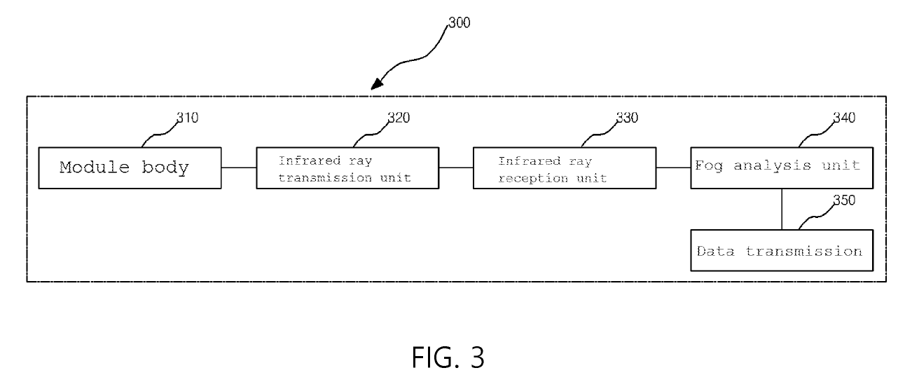

As shown in FIG. 3, the fog sensor module 300 includes a module body 310, an infrared ray transmission unit 320, an infrared ray reception unit 330, a fog analysis unit 340, and a data transmission unit 350.

The module body 310 is formed in the shape of a square box, and functions to protect individual devices from external pressure and to support them.

The infrared ray transmission unit 320 is located on the front surface of the head part of the module body, and functions to emit infrared rays while facing forward.

The infrared ray reception unit 330 is located on one side of the infrared ray transmission unit, and functions to receive infrared rays which hit fog particles and are scattered and returned.

The fog analysis unit 340 functions to analyze whether the fog in question is thick fog or thin fog based on the quantity of infrared ray signals received from the infrared ray reception unit.

The data transmission unit 350 functions to transfer the fog analysis data, obtained through the analysis of the fog analysis unit, to the smart control unit.

Next, the hybrid-type anion generating device 400 according to the present invention is described.

The hybrid-type anion generating device 400 is located on one side of the center portion of the support body, and functions to be operated in response to a control signal from the smart control unit and to generate anions by means of a hybrid method using corona discharge plasma and an electromagnetic field, thereby dispersing fog.

The hybrid-type anion generating device 400 includes a corona discharge plasma anion module 410 and an electromagnetic field anion module 420.

First, the corona discharge plasma anion module 410 according to the present invention is described.

The corona discharge plasma anion module 410 functions to be operated in response to a control signal from the smart control unit, to generate anions via corona discharge plasma, and to distribute the anions in the air, thereby dispersing fog.

In this case, a corona is an electrical discharge which emits weak light. Generally, corona appears at a sharp point, a corner, a thin electric wire, or the like where an electric field is sufficiently strong at atmospheric pressure.

Accordingly, a corona discharge is always non-uniform. Generally, a strong electric field, ionization, and light emission appear in the vicinity of an electrode.

A corona discharge is a non-local thermodynamic equilibrium discharge having low current density.

A corona discharge device includes a negative electrode line, and a positive electrode (a surface to be processed) into which DC power enters in the form of pulses.

When high negative voltage is applied to the line, a discharge becomes a negative corona.

Secondary electrons are discharged into plasma, and cations are accelerated into the line.

The front portion of moving electrons having a higher energy of about 10 eV followed by electrons having a relatively low energy of about 1 eV is called a “streamer.”

Inelastic collisions occur between the high-energy electrons and heavy particles, and thus chemical species having chemical reactivity are generated.

In other words, a corona discharge is a phenomenon in which current based on charges accumulated in a sharp needle or line-shaped object generates a needle-shaped discharge of about a few μA.

Such a discharge is generated on a high-voltage conductor or a grounded conductor in the vicinity of a charged surface, and is accompanied by faint light emission.

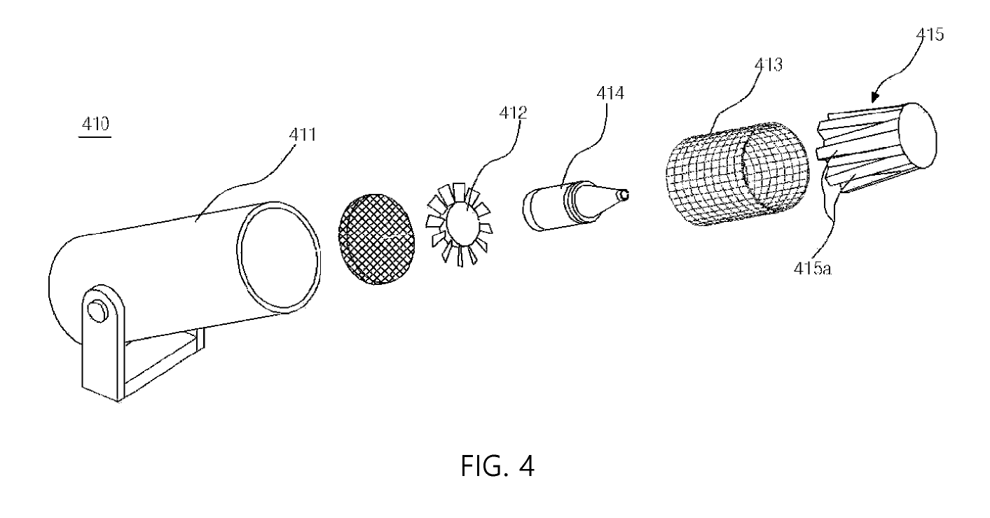

In view of these corona characteristics, the corona discharge plasma anion module 410 according to the present invention includes a first module body 411, a blower 412, a cylindrical plasma discharge electrode part 413, a high-frequency converter 414, and an eddy formation part 415, as shown in FIG. 4.

The first module body 411 is formed in a cylindrical shape, and functions to protect the individual devices from external pressure and to support them.

The blower 412 is disposed on one side of the back end of the first module body, and functions to inject the plasma anions, generated by the cylindrical plasma discharge electrode part, into the outside by blowing them in a backward direction.

The cylindrical plasma discharge electrode part 413 is located in front of the blower, and functions to generate plasma anions by applying high voltage to a plurality of ionizer electrodes formed on a cylindrical body surface in straight line shapes and thus generating a corona discharge.

The cylindrical plasma discharge electrode part 413 is formed in a cylindrical shape.

The high-frequency converter 414 functions to convert DC electricity having a voltage in the range from 10.0 to 20.0 kV, received from the rechargeable battery, into square wave pulses in the range from 10.0 to 45.0 kHz, and to flow the square wave pulses to the cylindrical plasma discharge electrode part.

The eddy formation part 415 is located in the internal space of the cylindrical plasma discharge electrode part, and functions to transmit the plasma anions, generated by the cylindrical plasma discharge electrode part, by generating eddies by means of eddy vanes 415a.

As shown in FIG. 4, the eddy formation part 415 receives the blowing forces of the blower generated at the back end portion, makes the plasma anions eddy along the eddy vanes, and guides the plasma anions so that they have a rectilinear movement property.

As described above, in the case of the occurrence of thick fog, when the corona discharge plasma anion module 410 according to the present invention, including the first module body 411, the blower 412, the cylindrical plasma discharge electrode part 413, the high-frequency converter 414, and the eddy formation part 415, generates anions via a needle-shaped corona discharge of about a few μA and injects the anions into the air where thick fog has occurred, the thick fog can be dispersed in the air within the range from 1 to 5 minutes.

Second, the electromagnetic field anion module 420 according to the present invention is described.

The electromagnetic field anion module 420 functions to be operated in response to a control signal from the smart control unit, to generate anions via an electromagnetic field, and to inject the anions into the air, thereby dispersing fog.

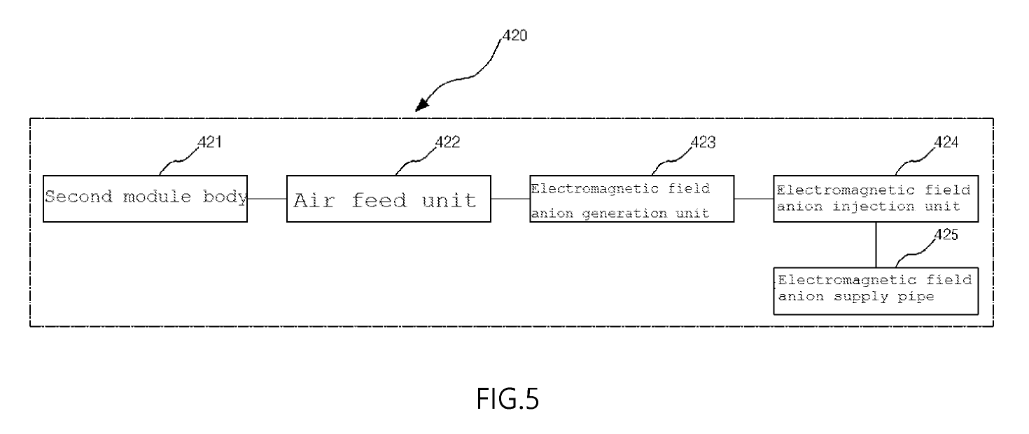

As shown in FIG. 5, the electromagnetic field anion module 420 includes a second module body 421, an air feed unit 422, an electromagnetic field anion generation unit 423, an electromagnetic field anion injection unit 424, and an electromagnetic field anion supply pipe 425.

The second module body 421 is formed in a cylindrical shape, and functions to protect the individual devices from external pressure and to support them.

The air feed unit 422 functions to suck air, and to transfer the air to the electromagnetic field anion generation unit.

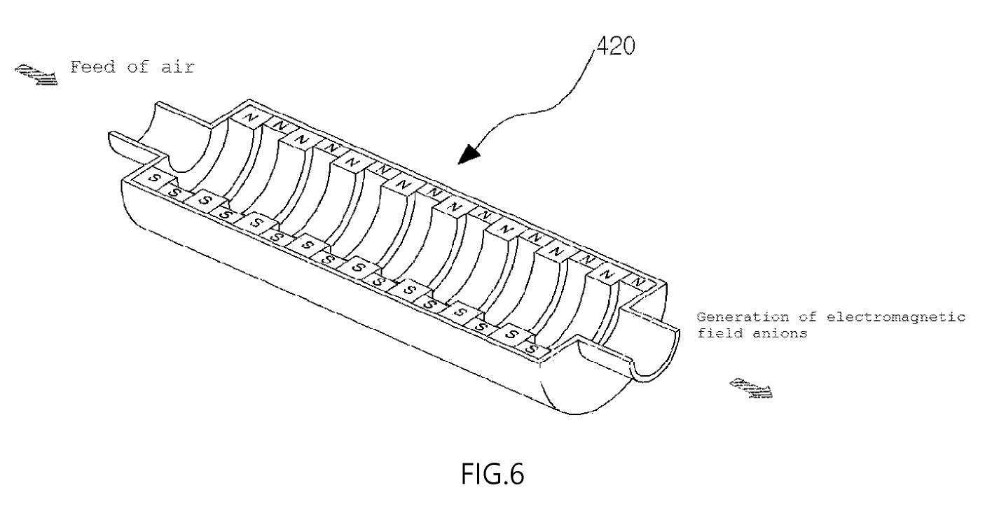

As shown in FIG. 6, the electromagnetic field anion generation unit 423 is formed by mounting magnets for generating a magnetic field inside a hollow cylindrical metallic pipe in a depression and protrusion form, and functions to generate electromagnetic field anions by generating an eddy flow, i.e., an irregular flow, in air entering from the air feed unit.

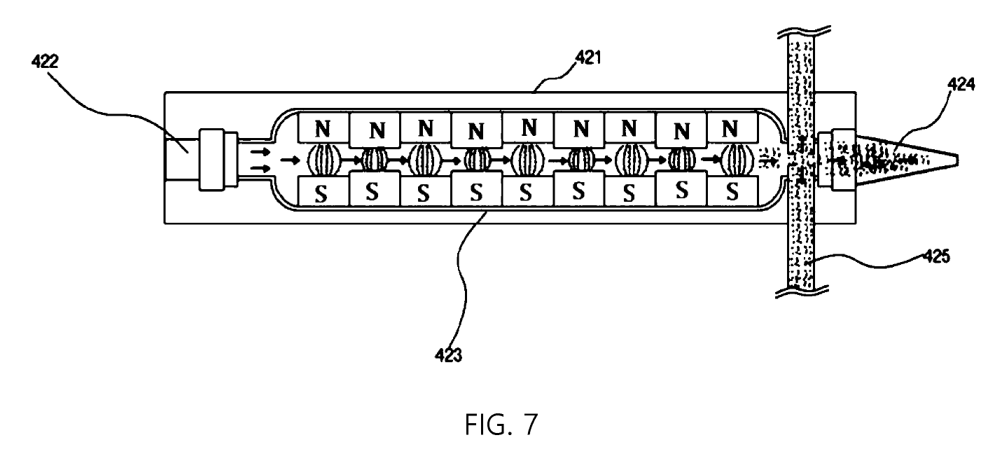

As shown in FIG. 7, the electromagnetic field anion injection unit 424 functions to pulverize the electromagnetic field anions generated via the electromagnetic field anion generation unit and to inject the pulverized anions into the outside.

The electromagnetic field anion injection unit 424 is formed to face upward in the angular range from 30° to 70°, or is formed to face in a direction in which a vehicle moves forward.

In this case, when the electromagnetic field anion injection unit is formed to face upward in the angular range from 30° to 70°, an inverted “V”-shaped shelter membrane may be generated by, in a state in which a symmetrical structure in which two electromagnetic field anion injection units are disposed to face each other has been formed, adjusting an anion injection direction to a direction toward the upper end of a specific space and then transmitting electromagnetic field anions in the direction toward the upper end of the specific space.

Furthermore, when the electromagnetic field anion injection unit 424 is formed to face in a direction in which a vehicle moves forward, the electromagnetic field anion injection unit 424 functions to disperse fog, generated in the direction in which the vehicle moves forward, via electromagnetic field anions by transmitting the electromagnetic field anions in the direction in which the vehicle moves forward.

In this case, the electromagnetic field anions transmitted in the direction in which the vehicle moves forward have a rectilinear movement property within the range from 10 to 50 m.

As shown in FIG. 7, the electromagnetic field anion supply pipe 425 functions to feed the electromagnetic field anions, generated via the electromagnetic field anion generation unit, to linear anion injection nozzles.

As described above, when the electromagnetic field anion module, including the second module body 421, the air feed unit 422, the electromagnetic field anion generation unit 423, the electromagnetic field anion injection unit 424, and the electromagnetic field anion supply pipe 425, is provided, particles in the atmosphere are ionized by means of a high-voltage electromagnetic field, and ions draw and condense fog particles while acting as condensation nuclei, thereby allowing the fog particles to fall in the form of raindrops.

Next, the smart control unit 500 according to the present invention is described.

The smart control unit 500 is connected to the fog sensor module and the hybrid-type anion generating device, and functions to control the overall operation of the individual devices, to receive fog data detected by the fog sensor module and perform control so that a drive control signal is output to the hybrid-type anion generating device, and to perform control so that the input fog data and system normality or abnormality data obtained at each set period are transmitted to a firefighting control center over a WiFi wireless communication network.

The smart control unit 500 is composed of a PIC one-chip microcomputer.

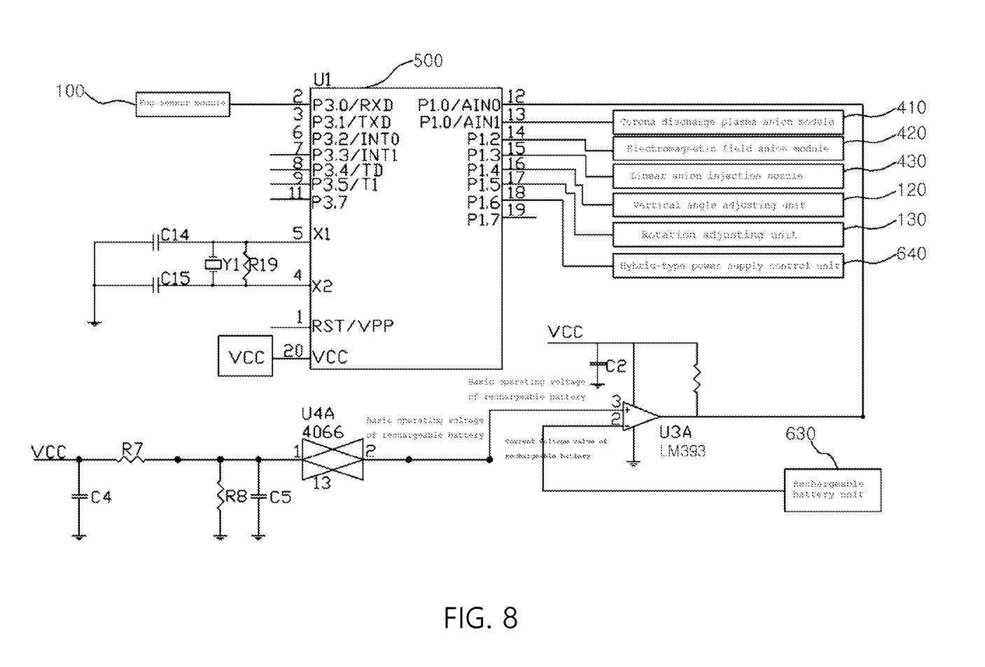

In other words, as shown in FIG. 8, the smart control unit 500 is configured to: be connected to the fog sensor module at one side of an input terminal thereof via a resistor R1 and receive fog analysis data obtained through the analysis of the fog sensor module; be connected to the corona discharge plasma anion module of the hybrid-type anion generating device at one side of an output terminal thereof via a resistor R10 and output a first drive control signal adapted to drive the corona discharge plasma anion module; be connected to the electromagnetic field anion module of the hybrid-type anion generating device at one side of another output terminal thereof via a resistor R11 and output a second drive control signal adapted to drive the electromagnetic field anion module; be connected to the linear anion injection nozzle of the hybrid-type anion generating device at one side of another output terminal via a resistor R12 and output a third drive control signal adapted to drive the linear anion injection nozzle; be connected to the charge control module at one side of still another output terminal thereof via a resistor R13 and output a charge selection control signal adapted to instruct that electrical energy generated via the solar panel be charged into the rechargeable battery for 50% of the total power and commercial power be received for 50% of the total power and be supplied to and charge the individual devices; be connected to the vertical angle adjusting unit at one side of still another output terminal resistor R14 and output a vertical angle adjustment signal adapted to adjust the corona discharge plasma anion module within the angular range from 10° to 70° in a vertical direction; and be connected to the rotation adjusting unit at one side of still another output terminal thereof via a resistor R15 and output a rotation angle adjustment signal adapted to perform adjustment to rotate all of the solar panel, the fog sensor module, and the hybrid-type anion generating device within the range from 1° to 360° in all directions.

Furthermore, the smart control unit 500 is configured to be connected to the warning light at one side of still another output terminal via a resistor R16, and to notify a vehicle driver of the occurrence of thick fog via warning sound or RGB color light emission.

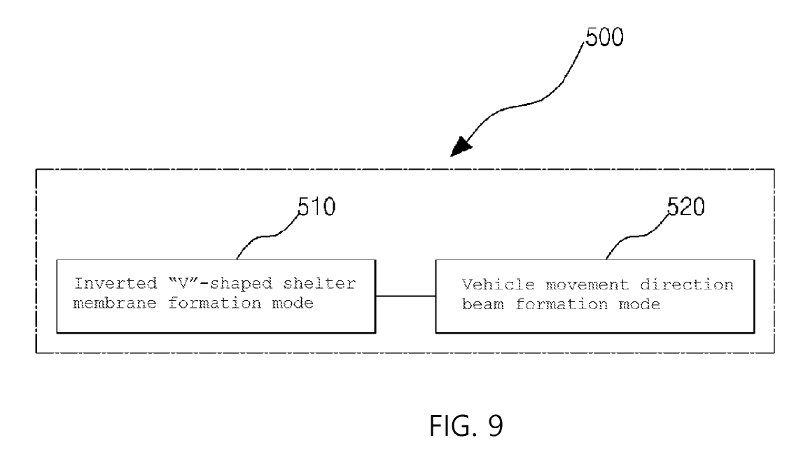

The smart control unit 500 according to the present invention receives the fog analysis data obtained through the analysis of the fog sensor module, and, when the input fog analysis data corresponds to thick fog, selects and drives at least any one of an inverted “V”-shaped shelter membrane formation mode and a vehicle movement direction beam formation mode, as shown in FIG. 9.

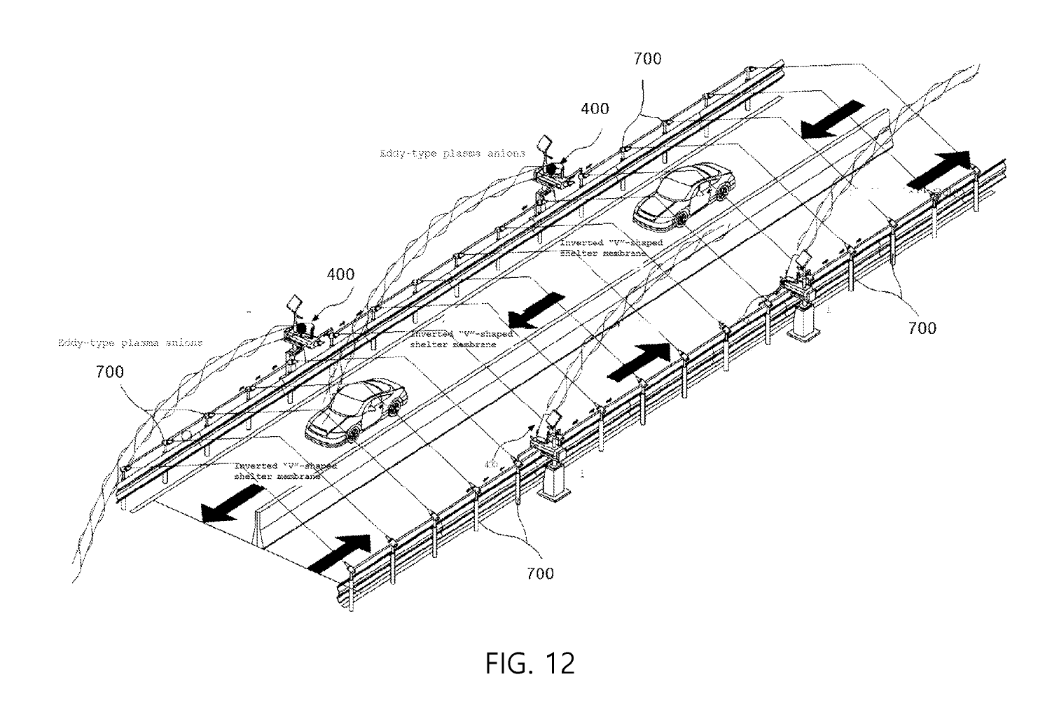

As shown in FIG. 12, the inverted “V”-shaped shelter membrane formation mode 510 functions to generate an inverted “V”-shaped shelter membrane by, in a state in which a symmetrical structure in which two linear anion injection nozzles are disposed to face each other has been formed, adjusting a nozzle injection direction to a direction toward the upper end of a specific space and then transmitting electromagnetic field anions in the direction toward the upper end of the specific space, thereby dispersing fog located within the internal space of the inverted “V”-shaped shelter membrane by means of electromagnetic field anions.

The inverted “V”-shaped shelter membrane formation mode 510 drives the linear anion injection nozzles.

In other words, the linear anion injection nozzles inject anions into the air while maintaining a rectilinear movement property in the range from 5 to 10 m. When the linear anion injection nozzles are installed in the angular range from 30° to 75°, an inverted “V”-shaped shelter membrane can be generated in a direction toward the upper end of a specific space.

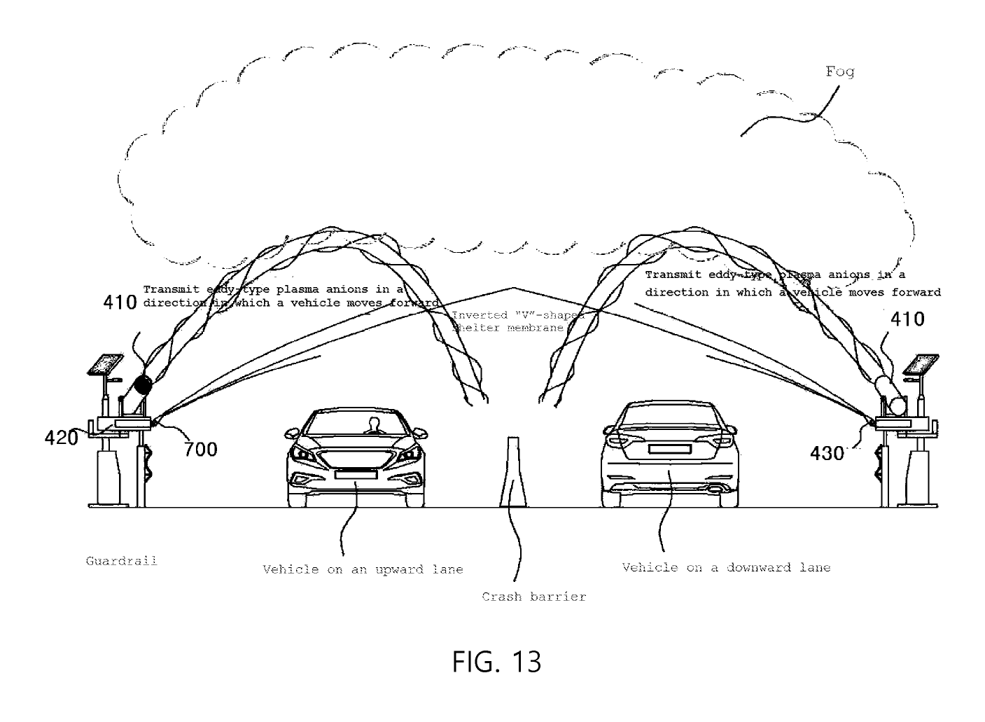

Since the inverted “V”-shaped shelter membrane formation mode 510 is configured as described above, an inverted “V”-shaped shelter membrane can be generated by transmitting electromagnetic field anions in a direction toward the upper end of a specific space, and fog located within the internal space of the inverted “V”-shaped shelter membrane can be dispersed by means of electromagnetic field anions, as shown in FIG. 13. Accordingly, the electromagnetic field anions can be collected in the form of the inverted “V”-shaped shelter membrane without being scattered into air, thereby improving fog dispersion rate by 80% compared to the conventional device.

The vehicle movement direction beam formation mode 520 functions to disperse fog generated in a direction in which a vehicle moves forward by means of corona discharge plasma anions by transmitting the corona discharge plasma anions in the direction in which the vehicle moves forward.

For this purpose, devices for removing fog using a hybrid-type anion generating device are installed at intervals in the range from 50 to 100 m.

Furthermore, the direction of the corona discharge plasma anion module is adjusted to the direction in which the vehicle moves forward via the vertical angle adjusting unit and the rotation adjusting unit.

The corona discharge plasma anions generated via the corona discharge plasma anion module according to the present invention are transmitted to the air while forming an eddy flow via the eddy formation part, as shown in FIGS. 12 and 13, thereby achieving a rectilinear movement property in the range from 30 to 100 m.

Since the vehicle movement direction beam formation mode 520 is configured as described above, fog generated in a direction in which a vehicle moves forward, i.e., in the direction of a traffic lane, can be dispersed by means of corona discharge plasma anions. Accordingly, the visual field of a vehicle driver can be improved, thereby reducing traffic accident rate attributable to the occurrence of fog by 70% compared to the conventional technology.

Furthermore, the smart control unit according to the present invention is connected to the WiFi wireless communication module at one side thereof.

In this case, the WiFi wireless communication module functions to transmit fog data input from the smart control unit and system normality or abnormality data obtained at each set period to a firefighting control center over a WiFi wireless communication network.

Next, the charge control module 600 according to the present invention is described.

The charge control module 600 is located on one side of the lower end portion of the support body, and functions to perform control so that any one of electricity generated by the solar panel and electricity supplied from a commercial power source is selected and charged into the rechargeable battery.

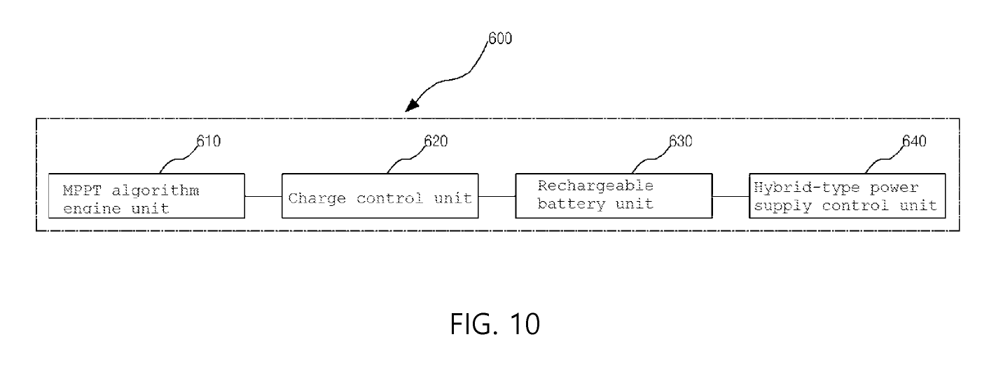

As shown in FIG. 10, the charge control module 600 includes an MPPT algorithm engine unit 610, a charge control unit 620, a rechargeable battery unit 630, and a hybrid-type power supply control unit 640.

First, the MPPT algorithm engine unit 610 according to the present invention is described.

In order to change the reference operating voltage of the rechargeable battery by comparing the current voltage value of the rechargeable battery with the previous voltage value thereof, the MPPT algorithm engine unit 610 functions to observe the output power of the rechargeable battery, to compare the observed output power with previous output voltage, to follow up a maximum power point by increasing or decreasing the operating voltage, and to control the charge control unit by generating a PWM signal based on the follow-up value.

The solar panel according to the present invention varies depending on incident solar light, the amount of solar radiation, wind, rain, dust in the atmosphere, light spectra on the ground surface, surface radiation light, a surface temperature, the contamination of a battery surface with impurities, an angle with respect to solar light based on an installation condition, a heat radiation device, etc.

Accordingly, control is performed via the PV array output control unit such that operation is performed at a specific point of an I-V characteristic curve where output is maximized.

In other words, when the amount of solar radiation varies, the current of the module is significantly changed, but the voltage of the module is not changed.

The fact that a maximum output point MPP is curved inward as the amount of solar radiation varies means that the input terminal voltage of an inverter continuously varies depending on the amount of solar radiation.

MPPT efficiency refers to the ratio of maximum output determined based on the I-V characteristics of an array to power received in the case of actual application to the charge control unit.

This is represented by Equation 1 below:

$${η}_{MPPT} = \frac{{P}_{IN}}{{P}_{MPP}} \times 100 [ \% ] \qquad ( 1 )$$

where η_{MPPT} is the MPPT efficiency, and P_{IN} and P_{MPP} are the power received by the input terminal of the charge control unit and the maximum output determined based on solar cell I-V characteristics, respectively.

A setting is made such that it is determined that the performance of an MPPT control function is desirably achieved only when η_{MPPT} has 95% or higher efficiency.

Second, the charge control unit 620 according to the present invention is described.

The charge control unit 520 is connected directly to the (+) and (−) connection jacks of the rechargeable battery of the rechargeable battery unit, and functions to read the input and output currents of the rechargeable battery, to perform detection and computation by means of a two-terminal network, and to, when the result of the computation falls within the maximum output point MPP range of the MPPT algorithm engine unit, perform charging so that varying current decay (VCD) is applied in a short pulse form up to a reference set voltage of 4.2 V according to set instantaneous time t.

As an example, when the rechargeable battery of a rechargeable battery unit having a rated capacity of 2500 mAh is charged such that the VCD function 40 of Equation 2 is applied in a short pulse form up to a reference set voltage of 4.2 V according to instantaneous time t (in this case, I₀ is set to an initial current of 5 A, k₁, k₂, and k₃ are set to constants, and the total time is set to 5400 s), this is represented by the following equation:

$$I ( t ) = \frac{{I}_{0} + {k}_{1} {t}^{1 / 2}}{1 + {k}_{2} {t}^{1 / 2} + {k}_{3} t} \qquad ( 2 )$$

By means of the charge control unit according to the present invention, the desired charge state of the rechargeable battery can be reached within a shorter period of time than conventional CC-CV and CV charging methods.

The rechargeable battery capacity of the rechargeable battery unit composed of a lithium-ion battery is also influenced by a charging method.

In other words, when charge current is high, charging is performed within a shorter period of time, but capacity reduction rate increases. In contrast, in the charge control unit according to the present invention, slight excessive charging occurs due to the elapse of a cycle, but rapid charging having low capacity reduction rate can be achieved through the optimization of a current value.

Furthermore, although there is concern about the exceeding of an upper limit voltage at a positive electrode due to an increase in the electric potential of a negative electrode attributable to the elapse of a cycle, an adjustment can be made such that the electric potential cannot increase to the upper limit voltage or higher when the charge control unit according to the present invention is optimized.

As a result, charging can be safely performed at rapid speed without the degrading of an active material resulting from excessive charging.

Third, the rechargeable battery unit 530 according to the present invention is described.

The rechargeable battery unit 530 is formed in an eight-rechargeable battery cell structure, and is configured such that the input current detection terminal of the charge control unit is connected to a (+) connection jack of each rechargeable battery, the input voltage detection terminal of the MPPT algorithm engine unit is connected to the (+) connection jack of each rechargeable battery, the output current detection terminal of the charge control unit is connected to a (−) connection jack of each rechargeable battery, and the output voltage detection terminal of the MPPT algorithm engine unit is connected to a (+) connection jack of each rechargeable battery. The rechargeable battery unit 530 is rapidly charged via the charge control unit by means of an 8-channel, 2-terminal network method.

The rechargeable battery unit 530 is configured such that 50% of the charging batteries of the total rechargeable battery unit are charged with electricity generated by the solar panel and 50% of the charging batteries of the total rechargeable battery unit are charged with electricity transferred from a commercial power source.

The reason for this is to reduce the usage rate of commercial power to 50% in such a way as to charge the rechargeable battery by using electricity generated by the solar panel as a main power supply source when it is sunny and thus incident solar light and the amount of solar radiation are large and to charge the rechargeable battery by using electricity transferred from a commercial power as a main power supply source when it is cloudy or rains.

Furthermore, the charge control module 600 according to the present invention is configured to include the hybrid-type power supply control unit 640 which is connected directly to the (+) and (−) connection jacks of the rechargeable battery of the rechargeable battery unit 630 which performs control so that the rechargeable battery unit 630 is charged with electrical energy generated by the solar panel for 50% of the total power of the rechargeable battery unit 630 and 50% of the total power of the rechargeable battery unit 630 is supplied via a commercial power source.

As a result, electrical energy generated by the solar panel is charged into the rechargeable battery for 50% of the total power and used for self power, and 50% of the total power is supplied from a commercial power and supplied to the individual devices. The device for removing fog may be installed anywhere and anytime regardless of place via wireless power.

Furthermore, the device for removing fog using a hybrid-type anion generating device according to the present invention is configured to include linear anion injection nozzles 700 which are formed in linear structures based on the support body 100 and which receive electromagnetic field anions from the electromagnetic field anion supply pipe 424 and secondarily inject the electromagnetic field anions in a direction below the electromagnetic field anion module.

The linear anion injection nozzles 700 are driven by the inverted “V”-shaped shelter membrane formation mode 510 of the smart control unit, and transmit electromagnetic field anions in a direction toward the upper end of a specific space.

The linear anion injection nozzles 700 according to the present invention are formed in linear structures at intervals in the range from 5 to 10 m so that a plurality of linear anion injection nozzles forms a symmetrical structure while facing each other based on street trees.

Furthermore, in order to generate an inverted “V”-shaped shelter membrane by transmitting electromagnetic field anions in a direction toward the upper end of a specific space, the linear anion injection nozzles 700 are installed such that the linear anion injection nozzles are directed upward at an angle in the range from 30° to 75°.

Since the linear anion injection nozzles 700 according to the present invention are configured as described above, two adjacent linear anion injection nozzles 700 can block the inflow of fog by forming an inverted “V”-shaped shelter membrane, and can collect fog in the upper end region of a corresponding space and can lower the collected fog in a direction toward the lower end of the corresponding space, thereby ensuring the visible fields of the drivers of vehicles which are moving along a road.

The detailed operation process of the device for removing fog using a hybrid-type anion generating device according to the present invention will be described below.

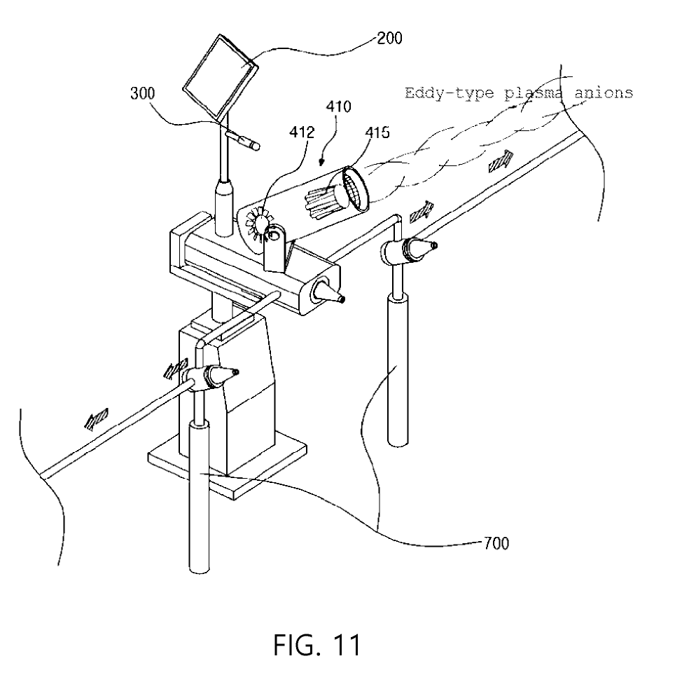

First, as shown in FIG. 11, the solar panel 200 collects solar light, generates electricity, and charges the generated electricity into the rechargeable battery.

Next, the power charged into the rechargeable battery is applied to the individual devices in response to a control signal from the smart control unit.

Next, the fog sensor module emits infrared rays forward, receives infrared rays which hit fog particles and are scattered, and then detects whether the fog in question is thick fog or thin fog.

Next, the smart control unit receives fog data obtained by the fog sensor module, and outputs a drive control signal to the hybrid-type anion generating device. In this case, when fog data regarding thick fog is received, the smart control unit drives both the corona discharge plasma anion module and the (+) electromagnetic field anion module. In contrast, when fog data regarding thin fog is received, the smart control unit drives only the electromagnetic field anion module.

Next, as shown in FIG. 12, the hybrid-type anion generating device is driven in response to a control signal from the smart control unit, generates anions according to a hybrid method using both corona discharge plasma and an electromagnetic field, and disperses fog by means of the anions.

In other words, the inverted “V”-shaped shelter membrane formation mode 510 is driven, an inverted “V”-shaped shelter membrane is generated by transmitting electromagnetic field anions in a direction toward the upper end of a specific space, and then fog located in the internal space of the inverted “V”-shaped shelter membrane is dispersed by means of the electromagnetic field anions.

Furthermore, the vehicle movement direction beam formation mode 520 is driven, corona discharge plasma anions are transmitted in a direction in which a vehicle moves forward, and then fog generated in the direction in which the vehicle moves forward is dispersed by means of the corona discharge plasma anions.

Finally, fog data input from the smart control unit and system normality or abnormality data obtained for each set period are transmitted to a firefighting control center over a WiFi wireless communication network.

[Description of reference symbols]

| | |
|---|---|
| 1: device for removing fog | 100: support body |
| 200: solar panel | 300: fog sensor module |
| 400: hybrid-type anion generating device | 500: smart control unit |
| 600: charge control module | |

1. A device for removing fog using a hybrid-type anion generating device, the device comprising:
a support body (100) formed to be upright in a vertical direction, and configured to protect individual devices from external pressure and to support them;
a solar panel (200) located on one side of an upper end of the support body, and configured to collect solar light, to generate electricity, and to charge the generated electricity into a rechargeable battery;
a fog sensor module (300) located on one side below the solar panel, and configured to emit infrared rays forward, to receive infrared rays which hit fog particles and are scattered and returned, to analyze whether fog in question is thick fog or thin fog, and to transfer fog analysis data to a smart control unit;
a hybrid-type anion generating device (400) located on one side of a center portion of the support body, and configured to be driven in response to a control signal from the smart control unit, to generate anions by means of a hybrid method using both corona discharge plasma and an electromagnetic field, and to disperse fog;
the smart control unit (500) connected to the fog sensor module and the hybrid-type anion generating device, and configured to control overall operation of the individual devices, to receive fog data detected by the fog sensor module and perform control so that a drive control signal is output to the hybrid-type anion generating device, and to perform control so that the input fog data and system normality or abnormality data obtained for each set period are transmitted to a firefighting control center over a WiFi wireless communication network; and
a charge control module (600) located on one side of a lower end portion of the support body, and configured to perform control so that any one of electricity generated by the solar panel and electricity supplied from a commercial power is selected and charged into the rechargeable battery;
wherein the hybrid-type anion generating device (400) comprises:
a corona discharge plasma anion module (410) configured to be driven in response to a control signal from the smart control unit, to generate anions via corona discharge plasma, and to inject the generated anions into air, thereby dispersing fog; and
an electromagnetic field anion module (420) configured to be driven in response to a control signal from the smart control unit, to generate anions via an electromagnetic field, and to inject the generated anions into air, thereby dispersing fog; and
wherein the corona discharge plasma anion module (410) comprises:
a first module body (411) formed in a cylindrical shape, and configured to protect individual devices from external pressure and to support them;
a blower (412) disposed on one side of a back end of the first module body, and configured to inject plasma anions, generated by the cylindrical plasma discharge electrode part, into an outside by blowing the plasma anions in a backward direction;
a cylindrical plasma discharge electrode part (413) located in front of the blower, and configured to generate plasma anions by applying high voltage to a plurality of ionizer electrodes formed on a cylindrical body surface in straight line shapes and thus generating a corona discharge;
a high-frequency converter (414) configured to convert direct current electricity having a voltage ranging from 10.0 to 20.0 kV, received from the rechargeable battery, into square wave pulses having a frequency ranging from 10.0 to 45.0 kHz, and to flow the square wave pulses to the cylindrical plasma discharge electrode part; and
an eddy formation part (415) located within an internal space of the cylindrical plasma discharge electrode part, and configured to transmit the plasma anions generated by the cylindrical plasma discharge electrode part by making the plasma anions eddy via eddy vanes.

2. The device of claim 1, wherein the electromagnetic field anion module (420) comprises:
a second module body (421) formed in a cylindrical shape, and configured to protect individual devices from external pressure and to support them;
an air feed unit (422) configured to suck air, and to transfer the sucked air to the electromagnetic field anion generation unit;
an electromagnetic field anion generation unit (423) formed by mounting magnets for generating a magnetic field inside a hollow cylindrical metallic pipe in a depression and protrusion form, and configured to generate electromagnetic field anions by generating an eddy flow, which is an irregular flow, in the air flowing from the air feed unit;
an electromagnetic field anion injection unit (424) configured to pulverize the electromagnetic field anions generated by the electromagnetic field anion generation unit, and to inject the pulverized electromagnetic field anions into the outside; and
an electromagnetic field anion supply pipe (425) configured to feed the electromagnetic field anions, generated via the electromagnetic field anion generation unit, to linear anion injection nozzles.

3. The device of claim 1, wherein the support body is made of a magnesium alloy coated with a coating layer, wherein the magnesium alloy is produced by melting and casting a basic Mg alloy billet, comprising 6.0 Al, 0.008 Cu, 0.004 Fe, 0.4 Mn, 0.008 Si, 0.2 Zn, and the remainder Mg, along with Zn and Sn in an electric resistance furnace in such a way as to load 0.5-2.0 wt % Sn, 0.5-2.0 wt % Zn, and the remainder Mg alloy billet, to melt the loaded materials while preventing a melt from being oxidized by means of air and SF gas, and to cast the melt under gravity, and wherein the coating layer is formed by mixing an aqueous solution of potassium permanganate with an aqueous solution of sodium hydroxide at a weight ratio of 1:3 to 4 to thus prepare a mixture solution, dipping the magnesium alloy in the mixture solution for 4 to 5 minutes while maintaining the mixture solution at a temperature of 50 to 70° C., taking the magnesium alloy out of the mixture solution, washing the magnesium alloy with water, performing air blowing on the magnesium alloy, and drying the magnesium alloy at 100° C. for 5 to 10 minutes.
